(19) United States
(12) Patent Application Publication
(10) Pub. No.: US 2024/0174104 A1
(43) Pub. Date: May 30, 2024

(54) BATTERY ASSEMBLY FOR A CHARGING STATION FOR ELECTRIC VEHICLES, CHARGING STATION COMPRISING SUCH A BATTERY ASSEMBLY AND BRIDGING ADAPTER FOR SUCH A BATTERY ASSEMBLY

(71) Applicant: ads-tec Energy GmbH, Nürtingen (DE)

(72) Inventors: Benjamin GREYE, Kirchheim (DE); Johannes SCHUCHTER, Grasbrunn (DE); Michael ZIMMER, Wolfschlugen (DE)

(21) Appl. No.: 18/511,266

(22) Filed: Nov. 16, 2023

(30) Foreign Application Priority Data
Nov. 24, 2022 (DE) 102022131175.9

(51) Int. Cl. B60L 53/302; B60L 53/60

(52) U.S. Cl. CPC B60L 53/302; B60L 53/60

(57) ABSTRACT

The invention relates to a battery assembly (3) for a charging station (1) for electric vehicles, comprising an installation frame (5), which has a plurality of receiving compartments (7), which are arranged adjacent to one another, whereby each receiving compartment (7) is configured to receive a battery module (11), whereby the receiving compartments (7) are open at least towards a front side (13) of the installation frame (5), so that the battery modules (11) can be introduced into the receiving compartments (7) from the front side (13).

The invention relates to a battery assembly for a charging station for electric vehicles, a charging station comprising such a battery assembly and a bridging adapter for such a battery assembly.

A charging station for electric vehicles follows from the EP 3 466 748 A1, which has a battery as energy storage. Such batteries are typically large and unwieldy. They additionally have a voltage level, which is not permitted in particular for the handling by laypersons. An adaptation of the batteries to a supply situation, which prevails concretely at the location of the charging station, or to a need is hardly possible or not possible at all, and a cooling of the batteries during operation can be improved, in particular when such a batterie is air-cooled.

The invention is based on the object of creating a battery assembly for a charging station for electric vehicles, a charging station comprising such a battery assembly and a bridging adapter for such a battery assembly, whereby the mentioned disadvantages are reduced, preferably do not occur.

The object is solved in that the present technical teaching is provided, in particular the teaching of the independent claims as well as of the embodiments disclosed in the dependent claims and the description.

The object is solved in particular in that a battery assembly for a charging station for electric vehicles is created, whereby the battery assembly has an installation frame, which has a plurality of receiving compartments, which are arranged adjacent to one another. Each receiving compartment is configured to receive a battery module. The receiving compartments are open at least towards a front side of the installation frame, in particular additionally towards a rear side, so that the battery modules can be introduced into the receiving compartments from the front side. The battery assembly is advantageously constructed modularly in this way, whereby the individual battery modules can be inserted in a simple way into the receiving compartments assigned to them in each case as well as can be removed from them. Last but not least, in particular a maintenance of the battery module is significantly simplified thereby, and the costs associated therewith are low.

The receiving compartments are in particular formed as insertion spaces. The battery modules can in particular be inserted into the receiving compartments from the front side.

According to a further development of the invention, it is provided that the battery assembly additionally has a front plate, which is configured to be arranged on the front side of the installation frame and to close the receiving compartments when the front plate is arranged on the front side of the installation frame. The battery modules can thus be secured or held tightly in the receiving compartments in a very simple and simultaneously secure as well as stable manner, whereby all receiving compartments can be readily closed simultaneously, in particular by means of the front plate. The front plate furthermore provides for a secure coverage of the battery modules towards the front side, so that they are protected particularly well, in particular compared to the arrangement of a holding beam, which extends only in some regions over a front surface of the battery modules facing the front side.

According to a further development of the invention, it is provided that the front plate and the installation frame have corresponding fastening elements, which are configured to fasten the front plate to the installation frame. The front plate and the installation frame can be fastened to one another particularly easily and simultaneously securely in this way.

In one embodiment, the fastening elements are formed as—in each case corresponding—screwing elements, whereby a respective screwing element is in particular selected from a group consisting of: A Screw bore, a threaded element, in particular a nut or a thread introduced into the front plate or the installation frame, a stud bolt, and a threaded pin.

According to a further development of the invention, it is provided that the front plate has a plurality of ventilation openings for a cooling air flow flowing through the receiving compartments. This provides for an effective as well as efficient air cooling of the battery modules arranged in the installation frame.

In one embodiment, the ventilation openings are configured to direct the cooling air flow. This advantageously provides for a good and effective distribution of the cooling air flow in the installation frame over the front plate. The ventilation openings are in particular configured to direct the cooling air flow at the battery modules. The latter are thus flown around and cooled particularly well.

Two electrical contacts and in particular one control connection are in particular assigned to each receiving compartment and thus in particular also to each battery module, in particular an electronic interface, for example a serial interface, for example a CAN interface.

According to a further development of the invention, it is provided that on the rear side located opposite the front side of the installation frame, the battery assembly has a contacting plate, which is configured to contact the battery modules in the receiving compartments. The contacting plate is in particular configured to contact the battery modules electrically. In one embodiment, the contacting plate is additionally configured to contact the battery modules in terms of control.

The contacting plate is in particular configured to connect the battery modules to one another—electrically and in particular in terms of control—in series.

The contacting plate in particular has the two electrical contacts and in particular the control connection, in particular the electronic interface, for each receiving compartment and thus in particular for each battery module. In one embodiment, the contacting plate additionally has at least one guide and positioning pin for each battery module, preferably in each case two guide and positioning pins for the electrical contacts on the one hand and for the control connection on the other hand.

In one embodiment, the contacting plate and the installation frame have corresponding further fastening elements, which are configured to fasten the contacting plate to the installation frame. The contacting plate and the installation frame can be fastened to one another particularly easily and simultaneously securely in this way.

In one embodiment, the further fastening elements are formed as—in each case corresponding—further screwing elements, whereby a respective further screwing element is in particular selected from a group consisting of: A Screw bore, a threaded element, in particular a nut or a thread introduced into the contacting plate or the installation frame, a stud bolt, and a threaded pin.

According to a further development of the invention, it is provided that the battery assembly has at least one bridging adapter, which is configured to bridge—electrically and in particular additionally in terms of control—a receiving compartment, which is not fitted with a battery module, that is, a receiving compartment, which remains free, of the plurality of receiving compartments. This advantageously provides for a scaling of the battery assembly by arranging more or fewer battery modules in the installation frame, whereby in particular receiving compartments can remain free and can be bridged by means of the bridging adapter instead of the use of a battery module. The bridging adapter is in particular configured to bridge the contacting plate in the region of the receiving compartment, which remains free.

The bridging adapter can be inserted into a receiving compartment, which remains free, in particular from the front side, and can be pushed through all the way to the contacting plate, where it is brought into contact with the contacting plate. The bridging adapter in particular has a locking means for being mechanically locked in place with the contacting plate or for being clipped to the contacting plate.

The bridging adapter is in particular configured to connect the electrical contacts, which are assigned to the receiving compartment, into which the bridging adapter is inserted, in particular the electrical contacts of the contacting plate, to one another and to thus bridge them. The bridging adapter is in particular additionally configured to bridge the control connection assigned to the receiving compartment, in particular the control connection of the contacting plate, in particular to connect at least one input pin of the control connection to at least one output pin of the control connection.

According to a further development of the invention, it is provided that the battery assembly has at least one panel, which is configured to be arranged on the front plate and to cover at least one ventilation opening of the plurality of ventilation openings of the front plate. Ventilation openings of receiving compartments, which remain free, can in particular be closed in an advantageous manner in this way.

In one embodiment, the panel is configured to simultaneously cover a plurality of ventilation openings, in particular over an entire width of the front plate. Entire rows of receiving compartments of the installation frame can thus remain free in a particularly simple manner, whereby the assigned ventilation openings can be closed quickly by means of the panels.

According to a further development of the invention, it is provided that the installation frame has a plurality of installation units, which are arranged one on top of the other, of receiving compartments, which are arranged next to one another. The installation frame is thus advantageously constructed in a matrix-like manner.

In one embodiment, it is provided that the installation frame as a plurality of installation units, which are arranged one on top of the other, of three respective receiving compartments, which are arranged next to one another. In one embodiment, the installation frame in particular has seven installation units. The installation frame thus in particular has 21 (3×7) receiving compartments.

In one embodiment, the installation frame has an installation shelf, which has or forms the receiving compartments, and an installation housing, in which the installation shelf is arranged, in particular fastened. Advantageously, the installation housing can be easily inserted, in particular pushed, into a charging station housing of a charging station, and can in particular be fastened there.

In one embodiment, the front plate can be fastened to the installation shelf. Alternatively, the front plate can be fastened to the installation housing.

Alternatively or additionally, the contact plate can be fastened to the installation housing. Alternatively, the contact plate can be fastened to the installation shelf.

According to a further development of the invention, it is provided that the installation frame is inclined at least partially with respect to a vertical—in particular in the direction of the rear side. This advantageously provides for an improved cooling air flow through the installation frame for cooling the battery modules, in particular in that an inflow cross section of the receiving compartments on the front side and an outflow cross section of the receiving compartments on the rear side for the cooling air is increased. Due to the at least partial incline of the installation frame, it is in particular simultaneously ensured that the individual battery modules are flown against homogeneously. The cooling air preferably flows against the receiving compartments on the front side during the operation of the battery assembly geodetically from the top, whereby the cooling air flows through the individual receiving compartments from the front side towards the rear side and flows off geodetically to the bottom on the rear side.

The vertical is in particular an intended geodetical vertical direction of the installation frame, in particular a vertical direction, in which the receiving compartments are arranged one on top of the other.

The installation shelf is in particular inclined with respect to a housing front side of the installation housing—in particular in the direction of the rear side—in particular quasi tilted rearwards.

The receiving compartments are in particular also individually inclined with respect to the vertical. Insertable bottoms of the receiving compartments are in particular also inclined with respect to the vertical.

The installation space, in particular the installation shelf, is in particular inclined at least partially by an angle of 0.1° to 3°, in particular by 1.8°, with respect to the vertical. This means accordingly that the installation frame, in particular the installation shelf, is inclined at least partially with respect to a geodetical horizontal plane by an angle of 90.1° to 93°, in particular 91.8°.

In one embodiment, the housing front side of the installation housing is aligned vertically, while a housing rear side of the installation housing has the incline of the installation shelf. The contact plate can be fastened to the housing rear side of the installation housing in this way and can simultaneously securely contact the battery modules arranged in the receiving compartments.

According to a further development of the invention, it is provided that the battery assembly has at least one battery module.

The at least one battery module in particular has at least one module parameter, which is selected from a group, consisting of: A voltage of less than 120 V, in particular less than 60 V, in particular less than 40 V, in particular less than 35 V; and a mass of less than 30 kg, in particular less than 25 kg.

If the battery module has a voltage of less than 120 V, it advantageously falls below the low voltage with touch voltage, which is not life-threatening for adults and can thus be handled easily. If the battery module has a voltage of less than 60 V, it advantageously falls below the low voltage for everyone, even children and animals, and can thus be handled particularly easily—in particular also by any layperson. An electrical expert is thus in particular not required for handling the battery module, in particular also not for inserting in the or removing from the installation frame. Contact points of the battery module, which are arranged on a rear side of the battery module, which faces the contacting plate in the inserted state, and which are configured to be connected to the electrical contacts of the contacting plate, are in particular IP20 contact-protected, in particular as protection against short-circuit and/or arcs.

If the battery module has a mass of less than 30 kg, in particular less than 25 kg, it can be readily handled by an operator, whereby no special requirements are made on the physical strengths. The battery assembly as a whole can thus be assembled easily and quickly, even by layperson.

The at least one battery module preferably has a plurality of battery cells, which are in particular connected to one another in series. The battery module in particular has eight battery cells, which are connected to one another in series. The battery cells can in particular be formed as lithium-ion cells.

In one embodiment, the individual battery cells have a voltage of 4.2 V. Each battery module comprising eight battery cells thus in particular has a voltage of 33.6 V.

Each battery module in particular has a capacity of 5 kWh, in particular 4.787 kWh.

However, battery modules comprising differently installed battery cells—in particular by using the electrical contacts as well as the control connection, in order to contact the battery modules electrically and in terms of control—can advantageously also be combined with one another due to the modularly constructed battery assembly, in particular with different types of battery cells, battery cells with different voltages and/or battery cells with different capacities.

In one embodiment, the battery module has at least one installation adapter. In one design, the installation adapter is configured to be able to arrange an, in particular smaller battery module, which geometrically differs from the dimensions and/or the shape of the receiving compartments, in one of the receiving compartments. Alternatively or additionally, the installation adapter is formed as connection adapter and is configured to be able to connect a battery module, which is designed differently with respect to its electrical contacting or contacting in terms of control, to the contact plate.

According to a further development of the invention, it is provided that the battery assembly has a control device, which is configured to be connected—electrically and in particular in terms of control—to the battery modules. The control device is in particular configured to monitor the battery modules, in particular all battery cells, to ensure an operation in the permissible operating range of the battery cells, and/or to adapt all battery module and/or battery cell voltage to one another by means of passive balancing.

The control device is in particular connected to the contacting plate—electrically and in particular in terms of control. The control device is in particular connected to the battery modules via the contacting plate.

The object is also solved in that a charging station for electric vehicles is created, which has a battery assembly according to the invention or a battery assembly according to one or several of the above-described embodiments. In connection with the charging station, in particular those advantages result, which have already been described above in connection with the battery assembly.

In electrical engineering, any, in particular stationary or mobile device or electrical installation, which serves the purpose of supplying energy to mobile accumulator-operated equipment, machines, or motor vehicles, by means of a simple setting or plugging in, without inevitably having to remove the energy storage—for instance the traction battery of an electric vehicle—is referred to as charging station. Charging stations for electric vehicles are sometimes also referred to as “electricity charging stations” and can comprise several charging points. In particular direct current quick charging systems (high performance charging systems or high power charging systems, HPC systems) such as the so-called combined charging system (CCS), which is common in Europe, are known here. During the generic direct current charging, direct current from the charging station is fed directly into the battery of the vehicle and is, for this purpose, provided to, e.g., solar charging stations by means of a powerful rectifier, preferably of the charging station, from the power supply or by means of large buffer accumulators. A battery management system, which communicates directly or indirectly with the charging station, in order to adapt the current and voltage or to end the process when reaching a predetermined capacity limit, is located in the vehicle. Power electronics are thereby typically located in the charging station. Due to the fact that the DC connections of the charging station are connected directly—without detour via an AC/DC converter of the vehicle—to corresponding connections of the traction battery, high charging currents can be transferred with little loss, which provides for short charging times.

In one embodiment, the charging station is formed as a charging column.

With the battery assembly, the charging station is in particular a battery-supported charging station. The charging station is in particular a battery-supported quick charging station. The charging station in particular has at least one charging point, in particular exactly one charging point, or at least two charging points, in particular exactly two charging points.

In one embodiment, the charging station is connected to a power supply; in this case, the battery assembly in particular serves the purpose of buffering electrical energy and/or of increasing the charging power, in particular compared to a connection to the power supply without battery assembly. In another embodiment, the charging station is a self-sufficient charging station, in particular a mobile charging station, which is operated without connection to a power supply. In yet another embodiment, the charging station is configured to be selectively operated self-sufficiently or with connection to a power supply.

An electric vehicle, which is to be charged at the charging station, is in particular supplied with electrical energy from the battery assembly.

In one embodiment, the charging station has exactly one battery assembly. In another embodiment, the charging station has a plurality of battery assemblies—which are in particular formed identically. The battery assemblies can thereby be connected in parallel, for example in order to provide for a higher charging current, or can be operated independently of one another, for example in order to supply different charging points independently of one another. In one embodiment, the charging station has exactly two battery assemblies, which are connected parallel to one another or which are operated independently of one another.

In one embodiment, the electrical components of the charging station are designed for a voltage range from 0 V to 1000 V. The power electronics of the charging station are in particular designed for a voltage range from 150 V to 920 V. A fitting of the charging station with at least 6 to maximally 27 battery modules, which can each be charged and discharged completely, thus results for the voltage range of the power electronics. If one accepts that the battery modules are not charged completely, a fitting with up to 29 battery modules can also take place.

In one embodiment, the installation frame—in particular for reasons of a height limitation—comprises 21 receiving compartments (3×7), so that the charging station can be maximally fitted with 21 battery modules in this case.

In particular, a voltage range between the discharged and the completely charged state of the battery assembly from 384 V to 504 V results for a fitting with 15 battery modules; in the case of 21 battery modules, a voltage range from 537.6 V to 705.6 V follows accordingly.

The object is also solved in that a bridging adapter for a battery assembly according to the invention or a battery assembly according to one or several of the above-described embodiments is created, whereby the bridging adapter is configured to bridge a receiving compartment of the battery assembly, which is not fitted with a battery module and which remains free, electrically and preferably in terms of control. In connection with the bridging adapter, in particular those advantages result, which have already been described above in connection with the battery assembly or the charging station.

According to a further development of the invention, it is provided that the bridging adapter has two electrical bridging contacts, which are connected electrically conductively to one another, whereby the electrical bridging contacts are configured to each be electrically connected to an electrical contact of two electrical contacts assigned to the receiving compartment, which remains free, in particular to the electrical contacts of the contacting plate assigned to the receiving compartment, which remains free.

According to a further development of the invention, it is provided that the bridging adapter—in particular additionally—has a bridging connection, which is configured to bridge a control connection assigned to the receiving compartment, which remains free, in particular the control connection of the contacting plate assigned to the receiving compartment, which remains free.

The battery assembly in particular has a bridging adapter according to the invention or a bridging adapter according to one or several of the above-described embodiments.

The invention will be described in more detail below on the basis of the drawing, in which:

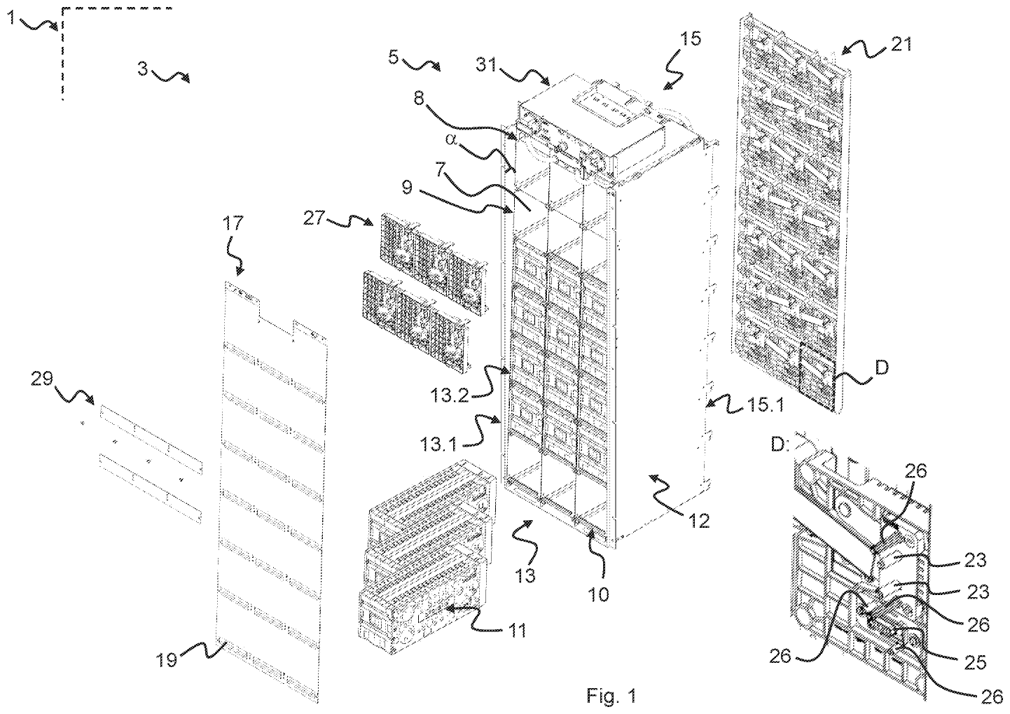

FIG. 1 shows a schematic exploded illustration of an exemplary embodiment of a battery assembly of a charging station, and

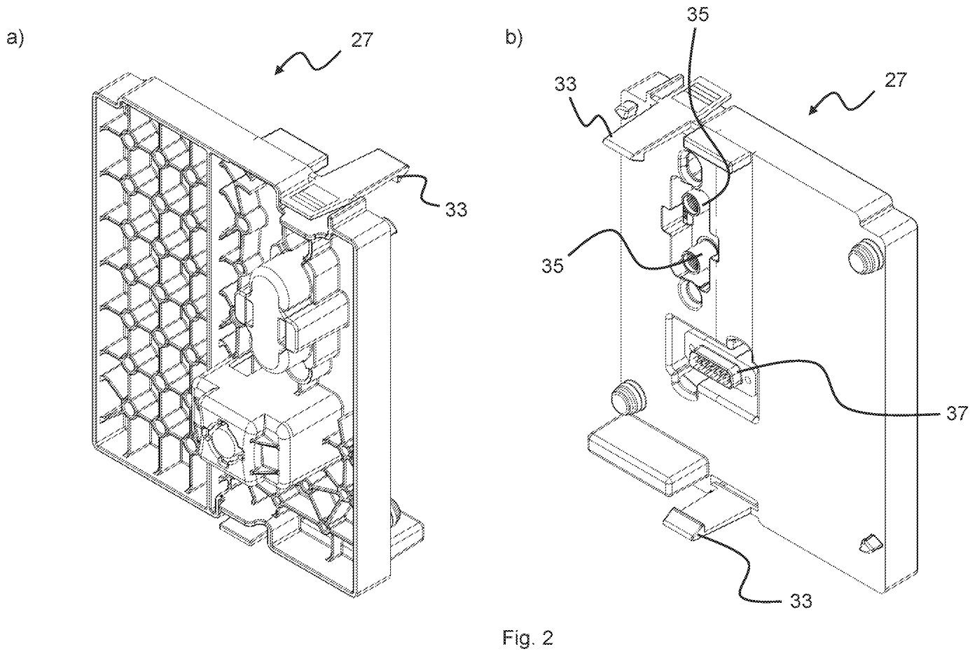

FIG. 2 shows an illustration of an exemplary embodiment of a bridging adapter.

FIG. 1 shows a schematic exploded illustration of the exemplary embodiment of a charging station 1 for electric vehicles with an exemplary embodiment of a battery assembly 3.

The battery assembly 3 has an installation frame 5, which has a plurality of receiving compartments 7 arranged adjacent to one another, only one of which is provided with a reference numerals here for the sake of clarity. The installation frame 5 in particular has seven installation units 9, which are arranged one on top of the other, for three respective receiving compartments 7, which are arranged next to one another; or, in other words, it has three installation columns 10 arranged next to one another for respective seven receiving compartments 7, which are arranged one on top of the other. The installation frame 5 thus has a total of twenty-one (three times seven) receiving compartments 7. Each receiving compartment 7 is configured to receive a battery module 11. The receiving compartments 7 are open at least towards a front side 13 and towards a rear side 15 of the installation frame 5 located opposite the front side 13, whereby the battery modules 11 can be introduced into the receiving compartments 7 from the front side 13.

The installation frame 5 has an installation shelf 8 forming the receiving compartments 7 and an installation housing 12. The installation shelf 8 is arranged in the installation housing 12 and is inclined or tilted by an angle α in particular with respect to a housing front side 13.1 of the installation housing 12 in the direction of the rear side 15. The angle α is in particular from 0.1° to 3°, in particular 1.8°. A housing rear side 15.1 of the installation housing 12 is inclined or tilted in particular by the same angle a with respect to the housing front side 13.1.

The battery assembly 3 in particular additionally has a front plate 17, which is configured to be fastened to the front side 13 of the installation frame 5, in particular to be fastened via fastening elements, and to close the receiving compartments 7 when the front plate 17 is arranged on the front side 13 of the installation frame 5. The front plate 17 can in particular be fastened to a shelf front side 13.2 of the installation shelf 8.

The front plate 17 in particular has a plurality of ventilation openings 19 for a cooling air flow flowing through the receiving compartments 7.

On the rear side 15, the battery assembly 3 in particular has a contacting plate 21, which is configured to contact the battery modules 11 in the receiving compartments 7 in particular electrically and in terms of control. The contacting plate 21 is in particular configured to connect the battery modules 11 to one another in series electrically and in terms of control. The contacting plate 21 has—as shown in the detail D, which is illustrated in an enlarged manner—two electrical contacts 23 and a control connection 25 for each receiving compartment 7 and thus in particular for each battery module 11, as well as additionally preferably two respective guide and positioning pins 26 for the electrical contacts 23 on the one hand and for the control connection 25 on the other hand.

The contacting plate 21 can in particular be fastened to the installation frame 5 via further fastening elements. The contacting plate 21 can in particular be fastened to the housing rear side 15.1 of the installation housing 12.

The battery assembly 3 in particular has at least one bridging adapter 27, which is configured to bridge the contacting plate 21 electrically and in terms of control in the region of a receiving compartment 7, which is not fitted with a battery module 11. Two rows of three respective bridging adapters 27, which are arranged next to one another, by means of which two installation units 9 can be bridged accordingly, are illustrated schematically here.

The bridging adapters 27 can each be inserted into a receiving compartment 7 from the front side 13 and can be pushed through all the way to the contacting plate 21, where they are brought into contact with the contacting plate 21.

In particular, the battery assembly 3 additionally has at least one panel 29, which is configured to be arranged on the front plate 17 and to cover at least one ventilation opening 19. The panel 29 is in particular configured to simultaneously cover a plurality of ventilation openings 19, in particular over an entire width of the front plate 17. According to the six bridging adapters 27, which are arranged in two installation units 9, two panels 29 are illustrated here, which are configured to close the ventilation openings 19 assigned to the six bridging adapters 27.

The battery assembly 3 additionally has a control device 31, which is connected to the contacting plate 21 and via the latter to the battery modules 11 electrically and in terms of control. The control device 31 is in particular configured to ensure an operation within the safe operating range of the inserted battery cells and to preferably adapt all battery module and/or battery cell voltages to one another by means of passive balancing.

FIG. 2 shows an illustration of an exemplary embodiment of a bridging adapter 27.

Identical and functionally identical elements are provided with identical reference numerals in all figures, so that reference is made in each case to the preceding description in this respect.

The bridging adapter 27 in particular has locking means 33 in order to be locked in place mechanically with the contacting plate 21, in particular to be clipped to the contacting plate 21.

The bridging adapter 27 is in particular configured to connect the electrical contacts 23 of the contacting plate 21, which are assigned to the receiving compartment 7, into which the bridging adapter 27 is inserted, to one another and to thus bridge them. For this purpose, it in particular has corresponding bridging contacts 35, which are connected electrically conductively to one another. The bridging adapter 27 is additionally configured to bridge the control connection 25 of the contacting plate 21 assigned to the receiving compartment 7. For this purpose, the bridging adapter 27 in particular has a corresponding bridging connection 37.

1. A battery assembly (3) for a charging station (1) for electric vehicles, comprising an installation frame (5), which has a plurality of receiving compartments (7), which are arranged adjacent to one another, whereby each receiving compartment (7) is configured to receive a battery module (11), whereby the receiving compartments (7) are open at least towards a front side (13) of the installation frame (5), so that the battery modules (11) can be introduced into the receiving compartments (7) from the front side (13).

2. The battery assembly (3) according to claim 1, whereby the battery arrangement (3) has a front plate (17), which is configured to be arranged on the front side (13) of the installation frame (5) and to close the receiving compartments (7) when the front plate (7) is arranged on the front side (13) of the installation frame (5).

3. The battery assembly (3) according to claim 2, whereby the front plate (17) and the installation frame (5) have corresponding fastening elements, which are configured to fasten the front plate (17) to the installation frame (5).

4. The battery assembly (3) according to one any one of claims 2 to 3, whereby the front plate (17) has a plurality of ventilation openings (19) for a cooling air flow flowing through the receiving compartments (7), whereby the ventilation openings (19) are preferably configured to direct the cooling air flow in particular at the battery modules (11).

5. The battery assembly (3) according to any one of claims 2 to 4, whereby the battery assembly (3) has at least one panel (29), which is configured to be arranged on the front plate (17) and to cover at least one ventilation opening (19) of the plurality of ventilation openings (19) of the front plate (17), whereby the panel (29) is in particular configured to simultaneously cover a plurality of ventilation openings (19), in particular over an entire width of the front plate (17).

6. The battery assembly (3) according to any one of the preceding claims, whereby, on a rear side (15) located opposite the front side (13) of the installation frame (5), the battery assembly (3) has a contacting plate (21), which is configured to contact the battery modules (11) in the receiving compartments (7), in particular to connect them to one another in series.

7. The battery assembly (3) according to any one of the preceding claims, whereby the battery assembly (3) has at least one bridging adapter (27), which is configured to bridge a receiving compartment (7) of the plurality of receiving compartments (7), which is not fitted with a battery module (11).

8. The battery assembly (3) according to any one of the preceding claims, whereby the installation frame (5) has a plurality of installation units (9), which are arranged one on top of the other, of three respective receiving compartments (7), which are arranged next to one another, whereby the installation frame (5) in particular has seven installation units (9).

9. The battery assembly (3) according to any one of the preceding claims, whereby the installation frame (5) is inclined with respect to a vertical.

10. The battery assembly (3) according to any one of the preceding claims, whereby the battery assembly (3) has at least one battery module (11), whereby the at least one battery module (11) preferably has at least one module parameter, which is selected from a group, consisting of: A voltage of less than 120 V, in particular less than 60 V, in particular less than 40 V, in particular less than 35 V; and a mass of less than 30 kg, in particular less than 25 kg.

11. The battery assembly (3) according to any one of the preceding claims, whereby the battery assembly (3) has a control device (31), which is configured to be to be connected—electrically and in particular in terms of control—to the at least one battery module (11).

12. A charging station (1) for electric vehicles, comprising a battery assembly (3) according to any one of claims 1 to 11.

13. A bridging adapter (27) for a battery assembly (3) according to any one of claims 1 to 11, whereby the bridging adapter (27) is configured to bridge a receiving compartment (7), which remains free, of the battery assembly (3) electrically and preferably in terms of control.

14. The bridging adapter (27) according to claim 13, whereby the bridging adapter (27) has two electrical bridging contacts (35), which are connected electrically conductively to one another, whereby the electrical bridging contacts (35) are configured to each be electrically connected to an electrical contact (23) of two electrical contacts (23) assigned to the receiving compartment (7), which remains free.

15. The bridging adapter (27) according to any one of claim 13 or 14, whereby the bridging adapter (27) has a bridging connection (37), which is configured to bridge a control connection (25) assigned to the receiving compartment (7), which remains free.
